(19) United States
(12) Patent Application Publication
(10) Pub. No.: US 2015/0266285 A1
(43) Pub. Date: Sep. 24, 2015

(54) METHOD AND AN APPARATUS FOR CONTROLLING GRAIN SIZE OF A COMPONENT

(71) Applicant: SIEMENS AKTIENGESELLSCHAFT, Munchen (DE)

(72) Inventors: Allister William JAMES, Chuluota, FL (US); Michael OTT, Mulheim an der Ruhr (DE)

(73) Assignee: SIEMENS AKTIENGESELLSCHAFT, Munchen (DE)

(21) Appl. No.: 14/222,796

(22) Filed: Mar. 24, 2014

(51) Int. Cl. B23K 26/34; B23K 26/00; B22F 3/24; B22F 3/105

(52) U.S. Cl. CPC B33Y 40/00; B22F 3/24; B22F 3/1055; B23K 26/345; B23K 26/0093; B33Y 10/00; B33Y 30/00; B22F 2003/248; B22F 2003/1056; B22F 2301/15

(57) ABSTRACT

A method and an apparatus for controlling a grain size of a component generated using an additive manufacturing process. Construct a first fused layer of the component by fusing a plurality of layers of a fusible material, wherein the first fused layer has a thickness T₁. Thereafter, introduce stress through the first fused layer of the component. The component is generated by repeating the aforementioned steps. Further, the component is heated to a temperature above a recrystallization start temperature (Rxₛₜ) to control the grain size of the component.

### FIELD OF THE INVENTION

This invention relates to a field of additive manufacturing and in particular, to a method and an apparatus for controlling a grain size of a component manufactured using an additive manufacturing process.

### BACKGROUND OF THE INVENTION

In additive manufacturing techniques, a heat source is used to melt a specified amount of metal, which is in the form of a powder or wire, onto a base material. By repeating the process, layers of melted metallic powder are each arranged sequentially upon a preceding layer, resulting in the formation of a desired component. Additive manufacturing (AM) techniques can include selective laser melting (SLM), electron beam melting (EBM), laser metal forming (LMF), laser engineered net shape (LENS), or direct metal deposition (DMD). The invention is related mainly to the SLM additive manufacturing technique.

In the SLM technique, a laser beam scans a layer filled with metal or plastic powder, thereby melting and solidifying the powder in the areas of contact with the laser beam. The beam diameter of the laser is small, typical in the range of 100-300 um, thereby resulting in a small melt pool size. This leads to rapid solidification once the beam moves to another point on the layer. The time for solidification of a melted powder layer is limited, and the grain size in a solidified component is very small.

Components used in turbines or turbomachines need to operate at extremely high temperatures. Components with small grain size, such as those manufactured using AM techniques, deteriorate quickly due the effects of creep, stress rupture and thermo mechanical fatigue (TMF) and the like.

Further, materials such as Nickel and Cobalt based superalloys resist grain growth during service and retain the grain size developed during the manufacturing process. It is therefore necessary to control the grain size of the component manufactured using AM techniques.

### SUMMARY OF THE INVENTION

It is therefore, an object of the invention to achieve controlled grain growth in components manufactured using additive manufacturing (AM) techniques.

The aforementioned object is achieved by manufacturing a component for a turbomachine according to a method disclosed herein, and by a corresponding apparatus disclosed herein for construction of the component.

In accordance with the invention, the grain size of a component, manufactured using an additive manufactured process, is controlled using a method which comprises constructing a first fused layer of the component by fusing a plurality of layers of a fusible material using a heat source, wherein the first fused layer has a thickness T₁. Batch of the plurality of layers of fusible material is in powdered form before applying heat using the heat source. The fusible material is at least one of a metallic powder or a powdered alloy.

In accordance with the invention, stress is introduced through the first fused layer of the component. In an exemplary embodiment, the stress is introduced by deforming the first fused layer of the component. Subsequently, the stress is introduced into all of the plurality of the layers, such as the first fused layer, constituting the component. The process of heating the material layer to consolidate the powdered material and inducing stress components in the layer is repeated until the component is generated.

In accordance with the invention, after the component is generated, by assembling stress induced layers, the component is heated to a temperature above a recrystallization start temperature (Rxₛₜ) to control the grain size of the component.

When the component is heat treated at a temperature above the recrystallization start temperature (Rxₛₜ), the distorted grain structure of the cold-worked material undergoes recrystallization and grain growth takes place within the stress induced layers of the component. The degree of recrystallization and resultant grain size can be controlled by varying the amount of residual stress stored in the component, the heat treatment temperature, duration of the heat treatment and thickness of the plurality of layers constituting the component.

The advantage of the invention is that, the grain size of the component can be controlled by varying the thickness of the layers that are used to construct the component and the amount of compressive residual stress induced in the layers during the construction the component. The post heat treatment grain size of the component with stress induced layers is significantly larger than a component manufactured using an AM process without inducing strain.

Further, the control of the grain size of the component can be achieved by choosing the right material to construct the component. The grain size can also be controlled by the level of stress induced the layers while constructing the component. Furthermore, the grain size also depends on the time and temperature at which the component is heated for initiating recrystallization and grain growth.

In an embodiment of the invention, the stress is introduced in the component by mechanical deformation of the component. In some embodiments, the grain size is a function of the thickness T₁ of the plurality of layers constituting the component.

In accordance with an embodiment of the invention, the fusible material is at least one of a nickel based superalloy and a cobalt based superalloy. The component is designed to be used in turbomachinery where the component is exposed to extreme temperatures. The nickel and cobalt based superalloys are capable of withstanding extreme heat.

In an aspect of the present invention, an apparatus for generating a component having a controllable a grain size using an additive manufacturing process is disclosed. The apparatus includes a construction unit, wherein the construction unit generates a first fused layer of the component by fusing a plurality of layers of a fusible material using a heat source, wherein the first fused layer has a thickness T₁.

In a further aspect of the present invention, the apparatus comprises a stress inducing unit, wherein the stress inducing unit introduces stress through the first fused layer. The stress inducing unit is configured to introduce stress into the component which aids in controlling the grain size of the component. Furthermore, the apparatus includes a heat treatment unit for heating the component at a temperature above recrystallization start temperature (Rxₛₜ) to control the grain size of the component. The heat treatment unit may vary the temperature in order to modify the grain size of the component.

### BRIEF DESCRIPTION OF THE DRAWINGS

The figures illustrate in a schematic manner further examples of the embodiments of the invention, in which:

FIG. 1 illustrates a method of controlling a grain size of a component generated using an additive manufacturing process;

FIG. 2 illustrates an exemplary apparatus for controlling a grain size of a component;

FIG. 3A-3E illustrates various stages in the construction of the component using the exemplary apparatus;

FIG. 4 illustrates the exemplary apparatus operating in a build mode; and

FIG. 5 illustrates the exemplary apparatus operating in a stress inducing mode.

### DESCRIPTION OF EMBODIMENTS

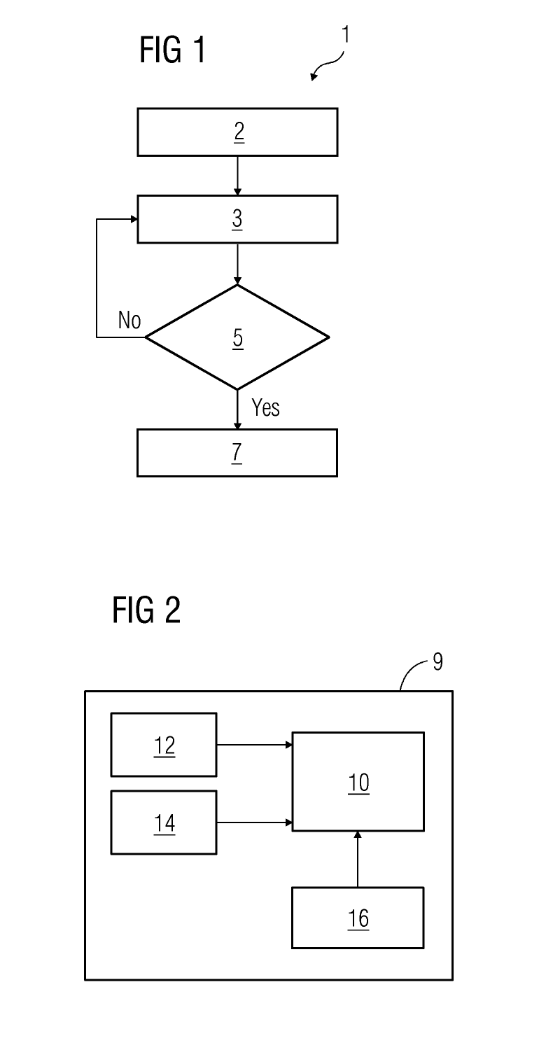

FIG. 1 illustrates a flow diagram of an exemplary method of controlling a grain size of a component generated using an additive manufacturing (AM) process. The AM process can include at least one of selective laser melting (SLM), electron beam melting (EBM), laser metal forming (LMF), laser engineered net shape (LENS), or direct metal deposition (DMD). At step 2, a first fused layer of the component is constructed by fusing a plurality of layers of a fusible material using a heat source. The plurality of layers of fusible materials may be, for example, a powdered metal or alloy. The heat source used to fuse the plurality of layers may be a high powered laser source. In some embodiments, the heat source may be an electric arc. The heat source is directed to melt specific quantities of the layers of material in order to fuse them to generate a first fused layer of the component. The first fused layer of the component has a thickness T₁. The thickness T₁ of the first fused layer is adjustable based on the grain size desired in the component. Further, the grain size is a function of the thickness T₁ of each of the plurality layers constituting the component.

At step 3, stress is introduced through the first fused layer of the component. In the preferred embodiment, the stress is introduced by deforming the first fused layer of the component. In some embodiments, deforming of the first fused layer of the component is performed using techniques such as, ultrasonic peening and laser peening. In the preferred embodiment, the stress introduced is compressive residual stress. The stress components may be introduced uniformly throughout the first fused layer. In some embodiments, the stress components may be introduced along the three dimensional structure of the first fused layer at various degrees. Further, the grain size of the component is a function of the level of stress induced within a plurality of layers constituting the component

At step 5, the steps 2 and 3 are repeated until the component is generated by AM process. The component is generated layer by layer, by fusing the metallic powder and introducing stress in the layer.

At step 7, after the component is generated, the component is heated to a temperature above a recrystallization start temperature (Rxₛₜ) to control the grain size of the component. The recrystallization start temperature (Rxₛₜ) depends on the fusible material used to construct the component. In some embodiments, the temperature to which the component is heated is varied based on the desired grain size. In the case of gamma prime strengthened nickel based superalloys the recrystallization temperature is above the gamma prime solution temperature.

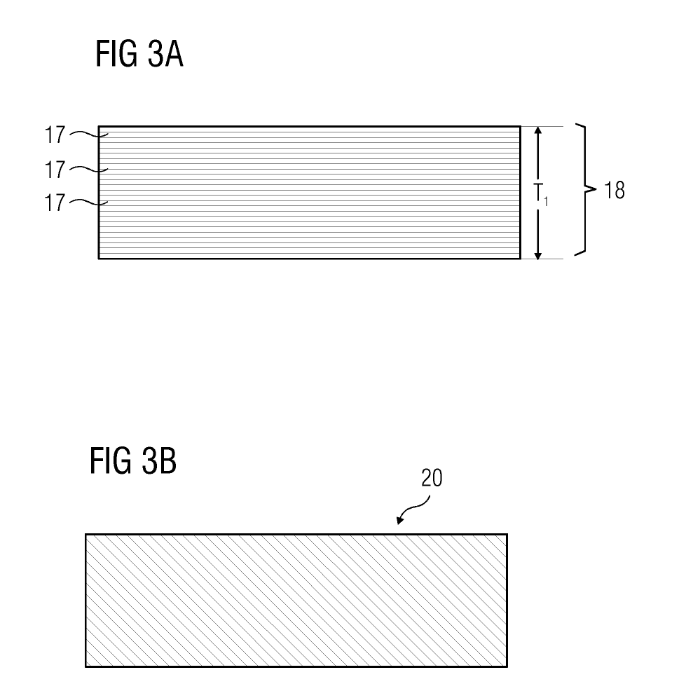

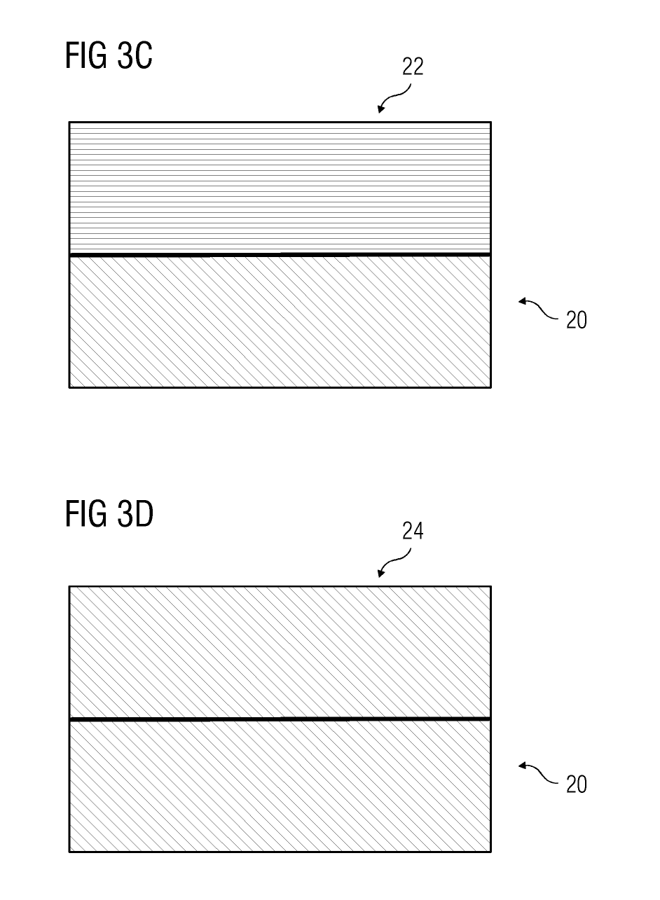

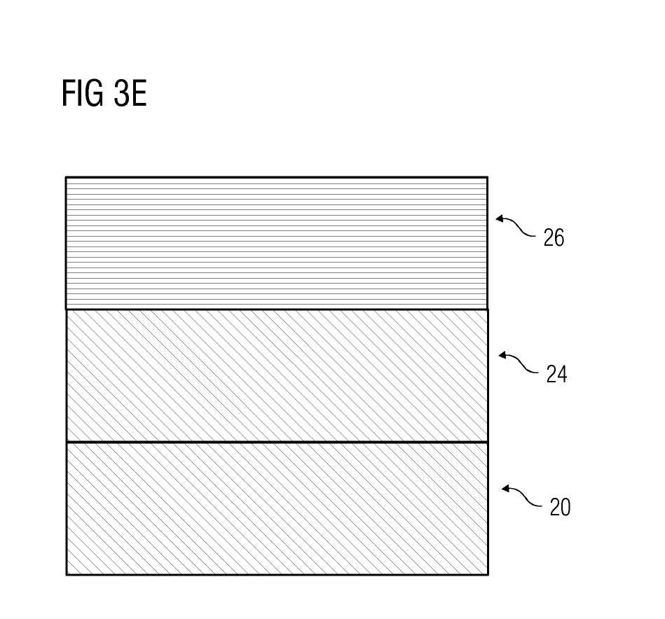

FIG. 2 illustrates an exemplary block diagram of an apparatus 9, for generating a component 10 having a controllable a grain size, using an additive manufacturing (AM) process. The apparatus includes a construction unit 12, a stress inducing unit 14 and a heat treatment unit 16. Further, FIGS. 3A-3E illustrate the different phases of the generation of the component having a controllable grain size, using the apparatus 9.

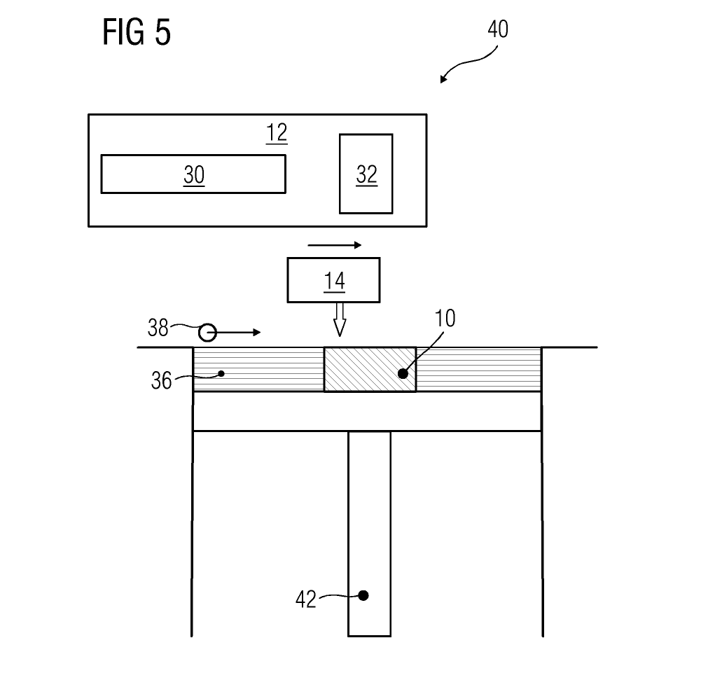

In the preferred embodiment, the construction unit 12 includes a heat source. The construction unit 12 generates a first fused layer of the component by fusing a plurality of layers of a fusible material 17 using a heat source, wherein the first fused layer has a thickness T₁. The plurality of layers of fusible material may be a portion of the layers of fusible material in a powder bed, which is used for constructing the component 10. The powder bed is further explained in FIG. 5. The heat source is at least one of a high powered laser source or an electric arc. The heat source of the construction unit melts layers of fusible material 17. The heat source makes multiple passes over the powder surface, fusing a portion of fusible material on the powder bed, to build a structure comprised of a plurality of consolidated layers to form fused layers, such as first fused layer 18, of the component 10. The first fused layer 18 of the component 10 is as shown in FIG. 3A. In an embodiment, the heat source is a high powered laser or an electric arc. The construction unit 12 includes provisions to store cross-sections of a sliced CAD (Computer Aided Design) model. The component 10 is constructed by scanning the sliced CAD model and using the heat source to melt the layers of powdered fusible material 17. The thickness T₁ of the first fused layer 18 is selected based on the desired grain size in the component 10.

The apparatus 9 includes the stress inducing unit 14 which introduces stress through the first fused layer 18. The stress inducing unit 14 introduces stress in the first fused layer 18 by deforming the first fused layer 18. Similarly, the stress inducing unit 14 introduces stress in all the layers constituting the component. Further, the stress inducing unit 14 may be configured to induce different levels of stress in each of a plurality of layers forming the component 10. The stress inducing unit 14 induces compressive residual stress within the layers based on the desired grain size of the component 10. Further, the grain size is a function of a level of stress induced within the plurality of layers constituting the component. FIG. 3B illustrates a stress induced layer 20, which is essentially the first fused layer 18 after introducing compressive residual stress components. Further, the construction unit is configured to generate the component by aligning a plurality of stress induced layers according to a shape of the component. For the purpose of constructing the component 10, the construction unit 12 uses sliced CAM models, as explained earlier.

Further, the construction unit 12 and the stress inducing unit 14 assembles the component 10 layer by layer, wherein each layer is formed by fusing a plurality of layers of fusible material and inducing stress into the fused layer, as illustrated in FIGS. 3A-3E. FIG. 3C illustrates the deposition of a second fused layer 22, over the stress induced layer 20, by again fusing a plurality of layers of fusible material. After fusing each layer, a new layer of fusible material is deposited over the fused layer. Thereafter, as illustrated in FIG. 3D, the stress inducing unit 14 introduces stress into the second fused layer 22, resulting in a second stress induced layer 24. It can be noted that the stress induced layers 20 and 24 are assembled on top of each other, to aid the construction of the component 10. Subsequently, as shown in FIG. 3E, a third layer of fusible material is deposited over stress induced layer 24. Further, the third layer of fusible material is fused by the heat source thereby forming third fused layer, on the second stress induced layer 24. Likewise the process of generating stress induced layers continues until the component 10 is generated.

Thereafter, the heat treatment unit 16, heats the component to a temperature above recrystallization start temperature (Rxₛₜ) to control the grain size of the component. The heat treatment unit 16 also accepts temperature values from a user and accordingly heats the component 10 to that temperature value. In an exemplary embodiment, apparatus 9 is configured to accept a grain size value from a user and sets one or more parameters of the construction unit 12, stress inducing unit 14 and the heat treatment unit 16 to achieve the desired grain size.

In some embodiments, the heat treatment unit 16 accepts a grain size value from the user and sets the temperature value so as the achieve user desired grain size. In some exemplary embodiments, the stress inducing unit 14 and the heat treatment unit 16 are configured to operate based on the grain size value.

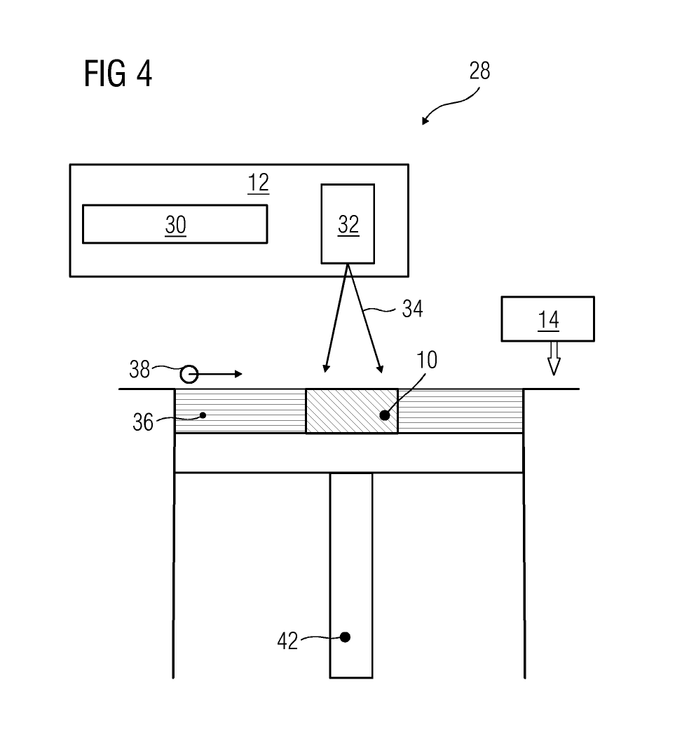

FIG. 4 illustrates an embodiment of the apparatus 28, similar to apparatus 9 as explained in FIG. 2, operating in a build mode. The construction unit 12, as shown in FIG. 4, includes a high power laser source 30 and a scanner system 32. In the build mode, the scanner system 32 directs laser beams 34 from the high powered laser source to fuse a plurality of layers of fusible material in a powder bed 36. The powder bed 36 includes a powdered fusible material such as, powdered metal or powdered alloy. The laser beam selectively fuses a portion of the fusible material in the powder bed 36 into a layer of the component 10. The dimension of the layer formed by fusing the fusible material on the powder bed is equal to the width of the laser beams 34 used to melt the material. The fused layer of the powder bed 36 may not be equal to the actual width or thickness of the component. The fusible material on the powder bed is fused layer by layer, according to a sliced CAM model, such that the component 10 is formed on the powder bed. In an embodiment, the scanner system 32 may include memory and processor to store the sliced CAM model and perform sintering of the fusible material based on the sliced CAM model. During the formation of the component, there may be unfused layers of fusible material of the powder bed, as the scanner system 32 selectively fuses the layers of fusible material based on the sliced CAM model. Further, one skilled in the art appreciates that the invention may be applied to other forms of additive manufacturing process including, for example, 3D printing techniques and any other material deposition techniques.

Further, the apparatus 28 includes stress inducing unit 14, which is an ultrasonic peening tool which induces compressive residual stress into the layer of the component generated by fusing a plurality of layers of the fusible material on the powder bed 36.

FIG. 5 illustrates the exemplary apparatus 40, similar to apparatus 9 as explained in FIG. 2, operating in a stress inducing mode. In the stress inducing mode, the laser beam from the scanning unit 32 is stopped and the stress inducing unit 14 is activated to induce compressive residual stress in the layer of the component generated by fusing the powder fusible material. In the preferred embodiment, the stress inducing unit 14 is an ultrasonic peening device, configured to induce compressive residual stress in the fused layer of the component 10. After inducing stress in the fused layer of the component, actuator 42 moves downwards to facilitate the construction unit 12 to generate the next layer of the component 10. The roller 38 spreads a layer of powder over the surface of the layer of component 10 in preparation for fusing by the laser beams 34. Similarly, the process of fusing the material and inducing stress components are repeated until the component 10 is generated. In the additive manufacturing process, the fusible material on the powder bed is fused only at certain portions according to the sliced CAM model. As a result, the powder bed 36 may contain fusible material which is not fused by the laser beam 34. The unfused material is removed from the powder bed 36 after the component 10 is generated.

Once the construction of the component 10 is finished, the component is heated by the heat treatment unit 16, wherein the component is heated to a temperature above the recrystallization start temperature (Rxₛₜ) to control the grain size of the component.

Though the invention has been described herein with reference to specific embodiments, this description is not meant to be construed in a limiting sense. Various examples of the disclosed embodiments, as well as alternate embodiments of the invention, will become apparent to persons skilled in the art upon reference to the description of the invention. It is therefore contemplated that such modifications can be made without departing from the embodiments of the present invention as defined.

1. A method for controlling a grain size of a component generated using an additive manufacturing process, the method comprising:
constructing a first fused layer of the component by fusing a plurality of layers of a fusible material, wherein the first fused layer has a thickness T₁;
introducing stress through the first fused layer of the component;
generating the component by repeating the aforementioned steps; and
heating the component to a temperature above a recrystallization start temperature (Rxₛₜ) to control the grain size of the component.

2. The method according to claim 1, wherein the component is generated using an Additive Manufacturing technique.

3. The method according to claim 2, wherein the Additive Manufacturing technique is selected from the group consisting of selective laser melting (SLM), electron beam melting (EBM), laser metal forming (LMF), laser engineered net shape (LENS), or direct metal deposition (DMD).

4. The method according to claim 1, wherein the stress introduction is by mechanical deformation of the first fused layer.

5. The method according to claim 2, wherein the Additive Manufacturing Technique produces grains of the fusible material in the first fused layer, and the grain size of the fusible material is a function of the thickness T₁ of the plurality of layers constituting the component.

6. The method according to claim 1, wherein the grain size of the fusible material is a function of a level of the stress induced within the plurality of layers constituting the component.

7. The method according to claim 1, the fusible material is a powdered form of least one of a nickel based superalloy and a cobalt based superalloy.

8. The method according to claim 1, further comprising selecting the recrystallization start temperature (Rxₛₜ) depends on the fusible material used to construct the component.

9. The method according to claim 1, wherein the fusible material is at least one of a powdered metal and a powdered alloy.

10. An apparatus for controlling a grain size of a component generated using additive manufacturing process comprising:
a construction unit for forming the component, and provided with a heat source;
a heat treatment unit for treating the component with heat to control grain size of the fusible material; and
a stress inducing unit provided with a means for introducing stress into at least one layer of the component.

11. The apparatus according to claim 10, wherein the heat source of the construction unit is located and configured to fuse a portion of a fusible material into a layer of the component.

12. The apparatus according to claim 10, wherein the construction unit is configured to generate the component by aligning a plurality of stress induced layers according to a shape of the component.

13. The apparatus according to claim 10, wherein the heat source is a high powered laser.

14. The apparatus according to claim 10, wherein the stress inducing unit is located and configured to introduce compressive residual stress to the plurality of layers of the component.

15. The apparatus according to claim 10, wherein the stress inducing unit is configured to induce different levels of stress using at least one of ultrasonic peening and laser peening.

16. The apparatus according to claim 10, wherein the apparatus is configured and operable to accept a grain size value provided by a user and to adapt the production of the component based on the grain size value.

17. The apparatus according to claim 10, wherein the stress inducing unit and the heat treatment unit are configured to operate based on the grain size value.
